(19) United States
(12) Patent Application Publication
(10) Pub. No.: US 2016/0069359 A1
(43) Pub. Date: Mar. 10, 2016

(54) PRESSURE VESSEL HAVING PLURALITY OF TUBES FOR HEAT EXCHANGE

(71) Applicant: Edward John HUMMELT, (US)

(72) Inventor: Edward John HUMMELT, Greenfield, WI (US)

(21) Appl. No.: 14/783,660

(22) PCT Filed: Apr. 10, 2014
(86) PCT No.: PCT/US20/33630

§ 371 Date: Oct. 9, 2015

Related U.S. Application Data
(60) Provisional application No. 61/811,579, filed on Apr. 12, 2013.
(60) Provisional application No. 61/845,716, filed on Jul. 12, 2013.

(51) Int. Cl. F15B 13/02

(52) U.S. Cl. CPC F15B 13/02

(57) ABSTRACT

A system for compressing gas includes a source of gas, a gas output location, first and second pressure vessels, first and second gas input lines for directing gas from the source of gas respectively to the first and second pressure vessels, first and second gas output lines for directing gas respectively from the first and second pressure vessels to the gas output location, a hydraulic system for moving hydraulic fluid back and forth between the first and second pressure vessels to compress gas in the first and second pressure vessels in an alternating manner. The first and second pressure vessels each include a plurality of tubes for containing the gas as the gas is pressurized and for absorbing heat generated as the gas is compressed.

### CROSS-REFERENCE TO RELATED APPLICATION(S)

This application is being filed on 10 Apr. 2014, as a PCT International Patent application and claims priority to U.S. Patent Application Ser. No. 61/811,579 filed on 12 Apr. 2013, and U.S. Patent Application Ser. No. 61/845,716 filed on 12 Jul. 2013, the disclosures of which are incorporated herein by reference in their entireties.

### INTRODUCTION

The need for highly pressurized gasses is growing. This is particularly true with the advent of natural gas vehicles, which depend on highly compressed gases instead of fossil fuels for operation. In compressing such gases, high compression pressure ratios, on the order of 200/1 or more, are commonly encountered. Such high pressure ratios require multistage compressors with intercooling, or if done in a single stage, lead to significant heat production, which can often times reduce the efficiency of the compression process.

### SUMMARY

In one embodiment, a system for compressing gas is described. The system includes a source of gas; a gas output location; first and second pressure vessels; first and second gas input lines for directing gas from the source of gas respectively to the first and second pressure vessels; first and second gas output lines for directing gas respectively from the first and second pressure vessels to the gas output location; a hydraulic system for moving hydraulic fluid back and forth between the first and second pressure vessels to compress gas in the first and second pressure vessels in an alternating manner, wherein gas is pressurized in the first pressure vessel by directing a first charge of gas from the source of gas into the first pressure vessel through the first gas input line and moving hydraulic fluid from the second pressure tank to the first pressure tank to compress the first charge of gas within the first pressure vessel, and wherein gas is pressurized in the second pressure vessel by directing a second charge of gas from the source of gas into the second pressure vessel through the second gas input line and moving hydraulic fluid from the first pressure tank to the second pressure tank to compress the second charge of gas within the second pressure vessel; and wherein the first and second pressure vessels each include a plurality of tubes for containing the gas as the gas is pressurized and for absorbing heat generated as the gas is compressed.

In another embodiment, a method for compressing gas is described. The method includes directing a charge of gas to a plurality of tubes in a first pressure vessel; moving hydraulic fluid into the pressure vessel to compress the charge of gas; and absorbing heat of compression with the plurality of tubes as the charge of gas is compressed. Pressure sensors can be provided at the compressed gas tank and/or at the first and second pressure vessels. Valves, pumps and other structures can be used to control hydraulic fluid flow and gas flow within the system.

In certain examples, the tubes provide a relatively large surface area and thermal mass that facilitates the effective transfer of heat from the compressed gas to the tubes during the compression process. In this way, the tubes function as heat sinks for absorbing heat during gas compression thereby limiting the temperature rise of the gas during compression. Ideally, the heat sink function provided by the tubes allows the compression process to take place in a more isothermal manner thereby improving the compression efficiency and allowing the overall size of the compression unit to be minimized. The heat absorbed by the tubes can be transferred from the tubes directly to the exterior environment. In certain examples, air or other media can be moved across the tubes to assist in transferring heat from the tubes to the environment. Alternatively, the heat absorbed by the tubes can be transferred from the tubes to the hydraulic fluid. A heat exchanger can be used to remove heat from the hydraulic fluid as the hydraulic fluid is moved between the first and second pressure vessels.

Another embodiment describes a pressure vessel in a compression system. The pressure vessel includes a plurality of tubes arranged in an array, the plurality of tubes each configured to assist in a compression process by receiving a first charge of gas and a volume of hydraulic fluid, wherein the volume of hydraulic fluid compresses the first charge of gas thereby resulting in an output of heat, and wherein the plurality of tubes absorbs an amount of the output of heat to control a temperature increase of the gas during compression.

These and various other features as well as advantages which characterize the systems and methods described herein will be apparent from a reading of the following detailed description and a review of the associated drawings. Additional features are set forth in the description which follows, and in part will be apparent from the description, or may be learned by practice of the technology. It is to be understood that both the foregoing general description and the following detailed description are exemplary and explanatory and are not intended to limit the scope of the various aspects disclosed herein.

### BRIEF DESCRIPTION OF FIGURES

FIG. 1 is an illustration of an embodiment of a gas compression system.

FIG. 2A is an illustration of an embodiment of a gas compression system having a gas compression circuit. The gas compression system is shown transferring hydraulic fluid from a first pressure vessel to a second pressure vessel to cause a charge of gas to be compressed within the second pressure vessel.

FIG. 2B shows the gas compression system of FIG. 2A with the hydraulic fluid being transferred from the second pressure vessel to the first pressure vessel to cause a charge of gas to be compressed within the first pressure vessel.

FIG. 3 is a diagram illustrating an embodiment of a pressure vessel.

FIG. 4 is an illustration of one embodiment of an arrangement of tubes within a gas compression vessel.

FIG. 5 is an illustration of another embodiment of an arrangement of tubes within a gas compression vessel.

FIG. 6 is a flow diagram representing an embodiment of a method for compressing gas.

### DETAILED DESCRIPTION

In general, the embodiments herein describe methods and systems for gas compression. In some embodiments, the gas compression system described herein can be used in connection with a natural gas vehicle, in which a compressed natural gas (“CNG”) is used as an alternative to fossil fuels. For example, the gas compression system includes a hydraulic system that can be selectively coupled (e.g., by a hose coupling) to a CNG tank used to power a natural gas vehicle. Due to needs for high-pressure (sometimes greater than 1500 psi or in the range of 1500-5000 psi) gas in this and other situations, the gas compression system described herein utilizes one or more compression chambers each including a plurality of tubes having a relatively high surface area and thermal mass. The relatively high surface area and thermal mass provided by the tubes allows the tubes to function as heat sinks for absorbing heat from the natural gas during the compression process. This allows the compression process to operate in a more isothermal manner thereby allowing better compression efficiencies to be achieved such that the overall size of the gas compression system can be minimized. Heat absorbed by the tubes can be transferred directly to the exterior environment or can be transferred through an intermediate working fluid to the exterior environment.

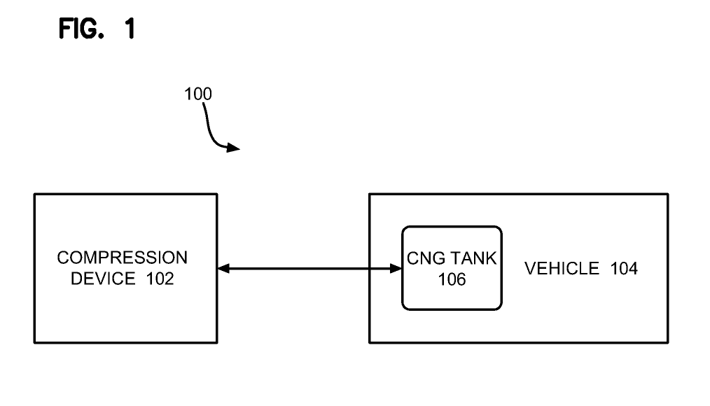

Referring now to FIG. 1, an example embodiment of a gas compression system 100 is shown. The system 100 includes a compression device 102 and a natural gas vehicle 104. The vehicle 104 includes a CNG tank 106. In general, FIG. 1 illustrates one embodiment of the system 100 in which the compression device 102 is selectively connected to the CNG tank 106 for the purpose of compressing natural gas and delivering the compressed natural gas to the vehicle 104. In one example, the compression device 102 can be provided at a tank filling location (e.g., a vehicle owner's garage, a natural gas filling station, etc.). To reduce the space occupied by the compression device as well as the cost of the compression device, it is desirable for the overall size of the compression device to be minimized. In use, the vehicle may park at the filling location at which time the compression device 102 is connected to the CNG tank 106 and used to fill the CNG tank 106 with compressed natural gas. In certain examples, the filling/compression process can take place over an extended time (e.g., over one or more hours or overnight). After the CHG tank 106 has been filled with compressed natural gas having a predetermined pressure level, the compression device 102 is disconnected from the CNG tank 106 and the vehicle is ready for use. In some embodiments, the system is capable of outputting a maximum gas pressure less than or equal to 4500 psi. In yet further embodiments, the system is capable of outputting a maximum gas pressure less than or equal to 4000 psi.

The vehicle 104 is a natural gas vehicle that includes the CNG tank 106. The vehicle 104 is powered by a compressed natural gas. In some embodiments, as shown, the CNG tank 106 is located within the vehicle 104 or otherwise carried by the vehicle 104. It is understood that in some examples, the vehicle 104 may include more than one CNG tank 106 which are each configured to be coupled to the compression device 102. In other embodiments, the compression device 102 can fill and intermediate CNG tank that is then used to fill CNG 106 carried by the vehicle 104.

The compression device 102 is arranged and configured to compress a volume of gas to relatively high pressures, for example, pressures greater than 2000 psi. In certain examples, the pressure ratio can be greater than 200/1. The compression device 102 utilizes a supply of natural gas and compresses the gas to a desired pressure. The compressed gas is delivered to the CNG tank 106 within the vehicle 104. In some embodiments, the supply of natural gas is provided as part of the compression device 102; however, in other embodiments, the supply of natural gas is external to the compression device 102. In certain examples, the supply of natural gas can be provided by a natural gas supply tank or a natural gas line that provides natural gas from a utility.

As will be described in greater detail below, the compression device 102 utilizes one or more pressure vessels for pressurizing the natural gas. The pressure vessels can be any size, but in some embodiments, the pressure vessels have a volume of less than 10 liters. During operation of the system 100, various components of the compression device 102 may be subject to temperature increases caused by heat generated as a result of the gas compression process. The pressure vessels in the compression device 102 utilize a plurality of tubes to meet both the thermal mass, heat transfer and structural pressure containment needs of the compression process.

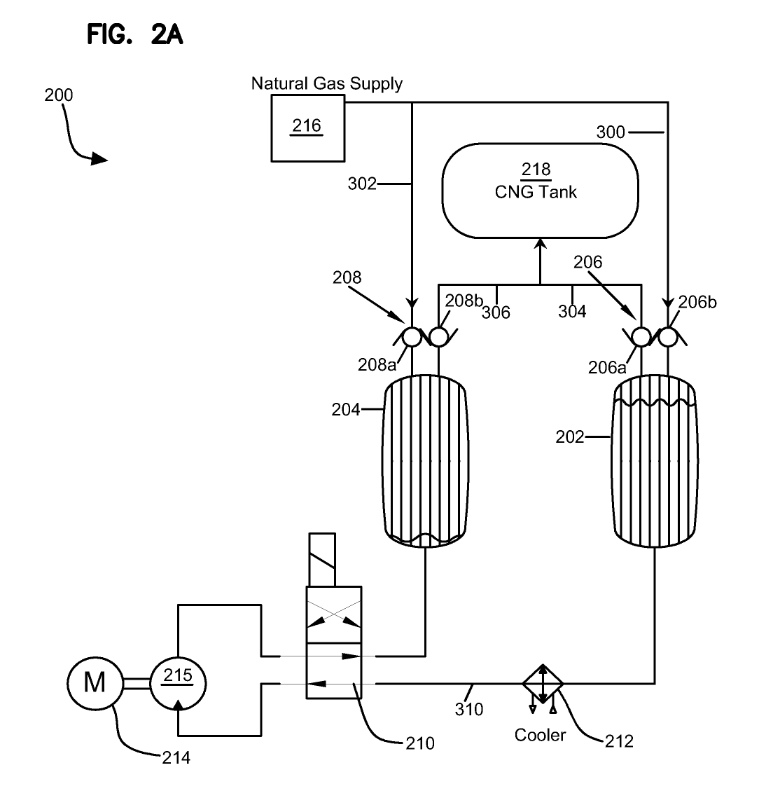

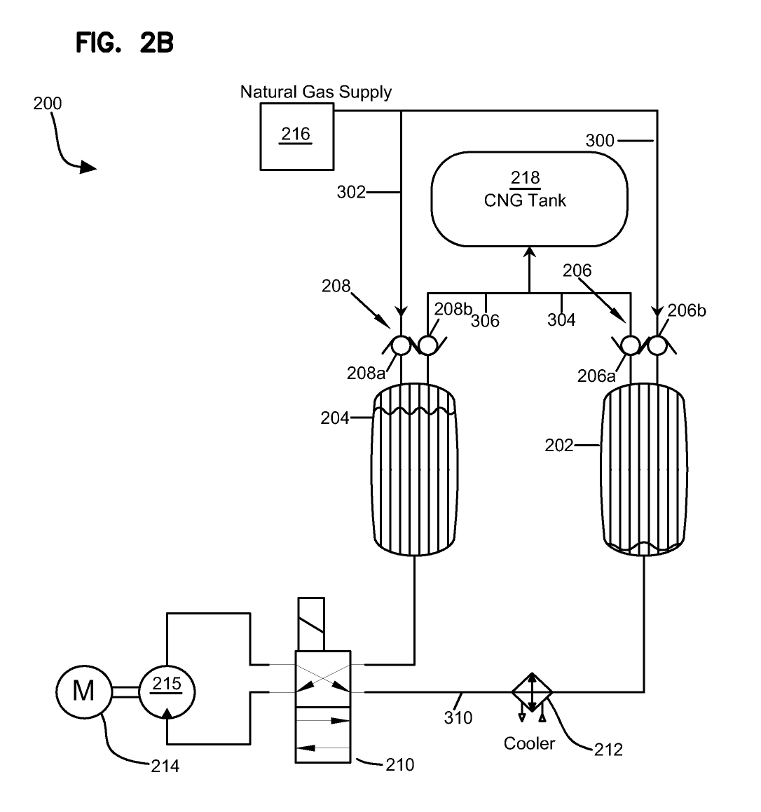

Referring now to FIGS. 2A and 2B, an example embodiment of a gas compression system 200 is shown. The gas compression system 200 includes a first pressure vessel 202, a second pressure vessel 204, a first set of valves 206, a second set of valves 208, a hydraulic fluid valve 210 (e.g., a two-position spool valve), a cooler 212, a motor 214 and a hydraulic pump 215. The gas compression system 200 is configured to interface with a natural gas supply 216 and a CNG tank 218. For example, the gas compression system can receive natural gas from the natural gas supply 216, and can deliver pressurized natural gas to the CNG tank 218. First and second natural gas input lines 300, 302 (i.e., vessel charge lines) direct natural gas from the natural gas supply 216 respectively to the first and second pressure vessels 202, 204. First and second natural gas output lines 304, 306 direct compressed natural gas from respectively from the first and second pressure vessels 202, 204 to the CNG tank 218. The first and second natural gas output lines 304, 306 can merge together and terminate at a fluid coupling (e.g., a hose coupling) used to selectively connect and disconnect the output lines 304, 306 to and from the CNG tank 218 as needed.

The first set of valves 206 can include one-way check valves 206a, 206b and the second set of valves 208 can include one-way check valves 208a, 208b. The one way check-valves 206a, 208a allow natural gas from the input lines 300, 302 to enter the pressure vessels 202, 204 while preventing the compressed natural gas from within the pressure vessels 202, 204 from back-flowing from pressure vessels 202, 204 through the input lines 300, 302 during gas compression. The one way check-valves 206b, 208b allow compressed natural gas to exit the pressure vessels 202, 204 through the output lines 304, 306 during gas compression while preventing compressed natural gas from CNG tank 218 from back-flowing into the pressure vessels 202, 204 through the output lines 304, 306.

The first and second pressure vessels 202, 204 are hydraulically connected by a hydraulic line 310. The cooler 212 (e.g., a heat exchanger) is positioned along the hydraulic line 310 and functions to extract heat from hydraulic fluid passing through the hydraulic line 310 such that the hydraulic fluid is cooled. The extracted heat can be transferred to the environment. The motor 214 and pump 214 input energy into the system for moving the hydraulic fluid through the hydraulic line 210 between the pressure vessels 202, 204 and for generating a hydraulic piston effect within the pressure vessels 202, 204 for compressing the natural gas within the pressure vessels 202, 204. The hydraulic valve 210 is positioned along the hydraulic line 310 and functions to control/alternate the direction in which the hydraulic fluid is pumped by the pump 215 through the hydraulic line 310 between the pressure vessels 202, 204.

In general, the gas compression system 200 receives natural gas from the natural gas supply 216 and alternatingly directs the gas through each of the first and second pressure vessels 202, 204 to pressurize the natural gas. The pressurized gas is delivered to the CNG tank 218. As stated above, in some embodiments, the CNG tank 218 can be located within a natural gas vehicle, such as the vehicle 104.

FIGS. 2A and 2B show the gas compression system 200 in first and second operating stages of a compression operating cycle. In the first operating state of FIG. 2A, the first pressure vessel 202 is filled with hydraulic fluid and the second pressure vessel 204 does not contain hydraulic fluid or is substantially void of hydraulic fluid. The hydraulic fluid can be selected from any number of fluids which have relatively low vapor pressures. Other qualities that are favorable in the hydraulic fluid include, for example, low absorptivity and solubility of component gases, chemically inert, constant viscosity (e.g., a viscosity index greater than 100), and/or having a pour point of less than 40 degrees Celsius. Some examples of suitable fluids include: glycols, highly refined petroleum based oils, synthetic hydrocarbons, silicone fluids, and ionic fluids. It is understood that this list is merely exemplary, and other fluids may be utilized.

When in the first state, a charge of natural gas is directed from the natural gas supply 216, through the second input line 302 and the check valve 208a into the second pressure vessel 204. Once the charge of natural gas has been supplied to the second pressure vessel 204, the hydraulic fluid valve 210 is moved to a first position (see FIG. 2A) in which the pump 215 pumps hydraulic fluid through the hydraulic line 310 from the first pressure vessel 202 to the second pressure vessel 204. As the second pressure vessel 204 fills with hydraulic fluid, the hydraulic fluid functions as a hydraulic piston causing the charge of natural gas within the second pressure vessel 204 to be compressed. Once the pressure within the second pressure vessel 204 exceeds the pressure in the CNG tank 218, compressed natural gas from the second pressure vessel 204 begins to exit the second pressure vessel 204 through the check valve 208b and flows through the output line 306 to fill/pressurize the CNG tank 218. This continues until the second pressure vessel 204 is full or substantially full of hydraulic fluid and all or substantially all of the charge of natural gas has been forced from the second pressure vessel 204 into the CNG tank 218. At this point, the gas compression system 200 is at the second operating state of FIG. 2B and the first pressure vessel 202 is void or substantially void of hydraulic fluid.

When in the second state of FIG. 2B, a charge of natural gas is directed from the natural gas supply 216, through the first input line 300 and the check valve 206a into the first pressure vessel 202. Once the charge of natural gas has been supplied to the first pressure vessel 202, the hydraulic fluid valve 210 is moved to a second position (see FIG. 2B) in which the pump 215 pumps hydraulic fluid through the hydraulic line 310 from the second pressure vessel 204 to the first pressure vessel 202. As the first pressure vessel 202 fills with hydraulic fluid, the hydraulic fluid functions as a hydraulic piston causing the charge of natural gas within the first pressure vessel 202 to be compressed. Once the pressure within the first pressure vessel 202 exceeds the pressure in the CNG tank 218, compressed natural gas from the first pressure vessel 202 begins to exit the first pressure vessel 202 through the check valve 206b and flows through the output line 304 to fill/pressurize the CNG tank 218. This continues until the first pressure vessel 202 is full or substantially full of hydraulic fluid and all or substantially all of the charge of natural gas has been forced from the first pressure vessel 202 into the CNG tank 218. At this point, the gas compression system 200 is back at the first operating state of FIG. 2A and the second pressure vessel 204 is void or substantially void of hydraulic fluid.

During a normal charging sequence/operation, it will be appreciated that the gas compression system 200 will be repeatedly cycled between the first and second operating states until the pressure within the CNG tank 218 is fully pressurized (i.e., until the pressure within the CNG tank 218 reaches a desired or predetermined pressure level). Though not shown, it is understood that one or more pressure sensors may be positioned at the CNG tank 218, along the output lines 304, 306 and/or at the pressure vessels 202, 204 for monitoring system pressures. It will be appreciated that a controller (e.g., an electronic controller) can be provided for controlling operation of the system. The controller can interface with the various components of the system (e.g., pressure sensors, valves, pump, motor, etc.). In some embodiments, the pump 215 can be bi-directional. In such embodiments, the spool valve 210 can be eliminated.

It will be appreciated that as the natural gas is compressed, the temperature increases. Such increases in temperature can negatively affect efficiency. For example, if the pressurized natural gas provided to the CNG tank has a temperature higher than ambient air, the pressure in the CNG tank will drop as the natural gas in the CHG tank cools. Thus, during charging, the CNG tank will need to be charged to a significantly higher pressure to compensate for the anticipated pressure drop which takes place when the natural gas in the CNG tank cools. In this regard, aspects of the present disclosure relate to enhancing the thermal transfer characteristics of the compression system 200 to inhibit the natural gas within the pressure vessels 202, 204 from increasing significantly in temperature during compression. In this way, the system can operate as close as possible to an isotheral system. To enhance the thermal transfer properties of the pressure vessels 202, 204, the pressure vessels 202, 204 can each include a plurality of tubes that contain/contact the natural gas during compression. The tubes provide an increased thermal mass for absorbing heat and an increased surface area for allowing the heat to be quickly transferred from the natural gas to the thermal mass. In certain examples, the tubes can be made of a material that effectively transfers heat (e.g., a metal material). Example materials include steel, for example ASTM A516 Grade 60 or AISI 4140; and wrought aluminum, generally 6000 series grades. Heat from the thermal mass of the tubes can be transferred to the hydraulic fluid as the hydraulic fluid contacts the exposed surface area of the tubes during filling of the pressure vessels 202, 204. In certain examples, the both the insides and outsides of the tubes can be exposed to natural gas and hydraulic fluid within the pressure vessels 202, 204. In certain examples, compression heat removed from the tubes by the hydraulic fluid can be removed from the system as the hydraulic fluid passes through the cooler 212. In other embodiments, heat from the thermal mass of the tubes can be transferred directly from the tubes to the ambient air. It will be appreciated that the tubes can be cylindrical or any other shape.

As described above, the first and second pressure vessels 202, 204 can each include a plurality of heat sink tubes. The tubes can each have a relatively small diameter to provide a large surface area that enhances the efficient heat exchange between the gas and the fluid in the first and second pressure vessel 202, 204. In one example, the presence of the plurality of tubes can eliminate the need for a granular thermal storage media within each of the first and second pressure vessels 202, 204. In other examples, the tubes can contain or be used in combination with a granular thermal transfer media. Each tube is arranged and configured to meet the pressure requirements of the compression process and interacts with the compressed gas to temporarily absorb and store compression heat that results from the compression process. In some embodiments, the tubes are arranged and configured to reject the resulting heat directly to its surrounding environment.

In one example, the plurality of tubes eliminate the need to provide thermal storage media within the pressure vessels 202, 204, and thus, lower the overall weight and cost of the pressure vessels 202, 204, due to the dual usage of the tubes as thermal storage and a pressure vessel. In addition, the tubes enable the design of a non-cylindrical (non-round cross section) pressure vessel. Further, in some examples, the tubes enable the system 200 to reject resulting heat without the need of a secondary radiator. In other examples, a cooler, such as the cooler 212 may be used as an added cooling mechanism for the system 200. However, due to the cooling effects of the plurality of tubes within each of the pressure vessels 202, 204, the cooler 212 is an optional component to the system 200.

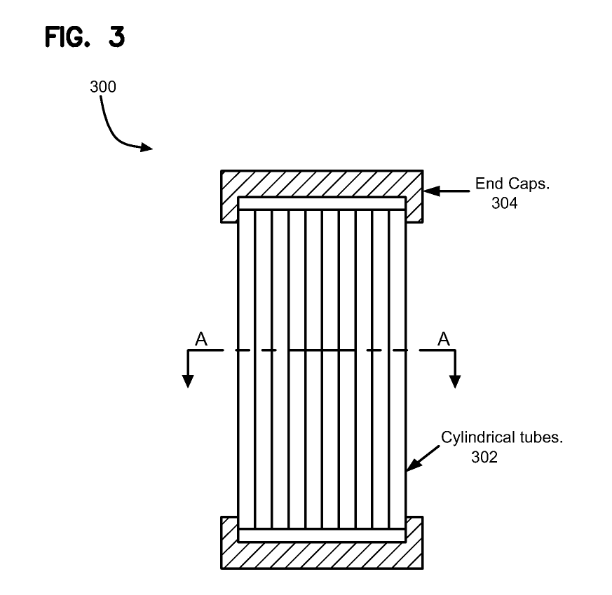

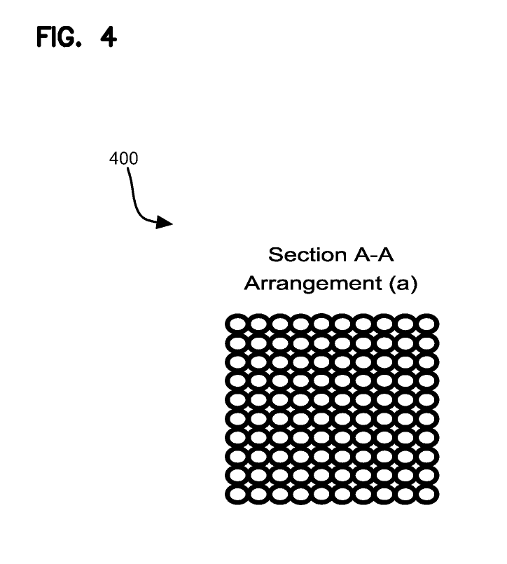

Referring now to FIG. 3, an example embodiment of a pressure vessel 300 is shown. The pressure vessel 300 includes a plurality of tubes 302 and end caps 304. The tubes 302 are arranged in an array. The end caps 304 can function as headers. The ends of the tube 302 can be secured at the headers and the headers can include perimeter seals that surround the outer perimeter of the tube array. The hydraulic line 310 can direct hydraulic fluid lower the lower end caps while the natural gas input and out lines can extend through the upper end caps. To maximize the surface are for transferring heat, both the inner and outer sides (e.g., the inner and outer diameters) of the tubes can exposed to natural gas and hydraulic fluid during the compression process (see FIG. 4).

In general, the tubes 302 are utilized for heat exchange between the hydraulic fluid and the gas. The tubes 302 allow the compression process to be closer to isothermal and improve compression efficiency. The tubes 302 provide a constant surface area to volume ratio throughout the volume of the pressure vessel 300 and are adequate to control gas temperature rise.

In some embodiments, each of the tubes has the same cross-dimension (e.g., diameter) and is hollow. In other examples, the tubes can have different cross-dimensions. In certain examples, at least some of the tubes have outer diameters in the range of 5 mm to 50 mm. In yet other embodiments, each of the plurality of tubes 302 has an outer diameter of less than 50 mm. In yet other embodiments, at least some of the tubes 302 have an outer diameter of less than 50 mm. In certain examples, at least some of the tubes 302 have a wall thickness in the range of 0.2 to 4 mm. As with the diameter of the tubes 302, in varying embodiments, each of the tubes may have the same or different wall thicknesses based on design needs or other related factors.

Each of the tubes 302 is arranged and configured to accept a flow of natural gas and/or hydraulic fluid. For example, hydraulic fluid flows into one or more of the tubes 302 which compresses natural gas held in the tubes 302. In some embodiments, the hydraulic fluid may be directed inside and outside the tubes for an additional cooling effect.

In some examples, the plurality of tubes 302 simultaneously contain pressure and provide the internal thermal storage and absorption ability needed to make the compression process nearly isothermal. In some arrangements of the tubes 302, the tubes 302 provide a direct path for heat transfer out of the system without the use of a secondary heat rejection device, such as, for example, a radiator or a cooler.

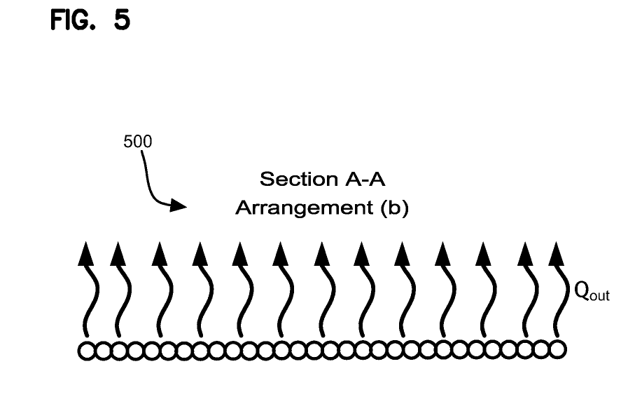

Referring now to FIGS. 4 and 5, two example embodiments of tube arrangements 400 and 500 within a pressure vessel, such as the pressure vessel 300, are shown. More specifically, the tube arrangements 400 and 500 are examples of the cross-sectional view of the plurality of tubes 302 shown in FIG. 3. The arrangement 400 shown in FIG. 4 is rectangular array with parallel tubes, while the arrangement 500 is a single-layer linear arrangement. Though only the arrangements 400 and 500 are shown, it is understood that pressure vessels may utilize a number of different tube arrangements, including, but not limited to circular, spherical, square, double-linear, etc.

The arrangements 400 and 500 enable the pressure vessel to simultaneously contain pressure and provide the internal thermal storage that is necessary to achieve a nearly isothermal process. In both arrangements 400, 500, the external tubes allow for greater heat release than the internal tubes. The arrangement 500 is beneficial because both inner and outer diameters of the tubes are exposed to gas thereby providing a large amount of surface are for allowing heat to rapidly be transferred from the natural gas to the tubes and from the tubes to the hydraulic fluid. The arrangement 400 is beneficial because it is thin and is suitable for wall mounting. Moreover, outer sides of the tubes can be exposed to ambient air thereby enhancing heat transfer from the tubes to the exterior environment.

In some embodiments, a cooling fluid may be utilized in conjunction with the tube arrangement to provide for further cooling. For example, a cooling fluid may flow between the internal tubes of the arrangement 400 or around the periphery of the tubes to provide an additional source of cooling.

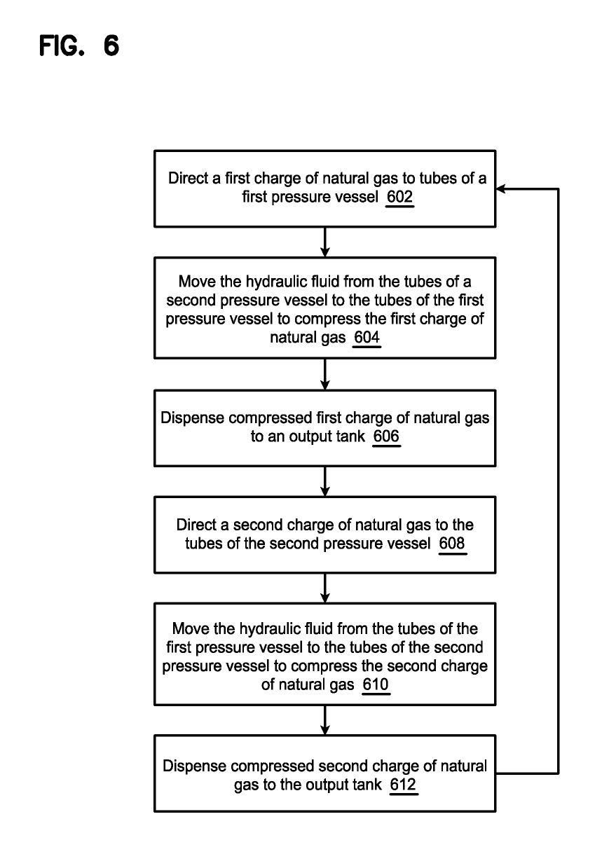

Referring now to FIG. 6, an example flow chart depicting a method 600 for gas compression is shown. In general, the method 600 is one example of a method for compressing gas. Although the method 600 will be described utilizing components illustrated in FIGS. 1-5, it is understood that such description is non-limiting.

The method 600 begins at operation 602 where a first charge of natural gas is directed to a first natural gas input line to a plurality of tubes of a first pressure vessel. For example, utilizing the system 200, a first charge of natural gas may be directed from the natural gas supply 216 to the first pressure vessel 202. In particular, the natural gas is directed through each of the plurality of tubes positioned within the first pressure vessel 202. In some embodiments, the gas may be directed inside and outside each of the tubes. During the first operation, the first pressure vessel 202 does not contain a substantial amount of hydraulic fluid and a second pressure vessel is substantially filled with hydraulic fluid. In one embodiment, for example, hydraulic fluid fills the tubes of the second pressure vessel 204. In some embodiments, the hydraulic fluid may be directed inside and outside each of the tubes.

Next, the method 600 moves to operation 604 where the hydraulic fluid is moved from the tubes of the second pressure vessel to the tubes of the first pressure vessel. For example, the hydraulic fluid is directed from the tubes of the second pressure vessel 204 to the tubes of the first pressure vessel 202 in an effort to compress the gas that is positioned within the tubes of the first pressure vessel 202.

When the pressure of the natural gas in the tubes of the first pressure vessel exceeds the pressure in the CNG tank, the system directs the compressed natural gas to the CNG tank during operation 606. In some embodiments, the output tank may be a CNG tank within or located near a natural gas vehicle. In other embodiments, the output tank may be any tank that is suitable to hold a volume of compressed gas.

The method 600 then moves to operation 608 where a second charge of natural gas is directed through a second natural gas input line to the tubes of the second pressure vessel. Because the second pressure vessel 204 is emptied in the operation 604, it is now ready to receive the second charge of gas from the natural gas supply 216. The natural gas flows through an alternate path, the second natural gas input line, into the tubes of the second pressure vessel 204, where it awaits compression.

The method 600 next proceeds to operation 610 where the hydraulic fluid is moved from the tubes of the first pressure vessel to the tubes of the second pressure vessel. The hydraulic fluid is moved in an effort to compress the second charge of gas residing in the second pressure vessel 204. When the pressure of the natural gas in the tubes of the second pressure vessel exceeds the pressure in the CNG tank, the system directs the compressed natural gas to the CNG tank during operation 612.

At this point, the method 600 may end if a desired volume of gas has been moved to the CNG tank and he pressure in the CNG tank has reached a desired level (3.g., greater than 1500 psi. However, if a desired amount of gas has not yet been compressed, the method proceeds back to operation 602. The alternating cycle continues until a desired amount of pressurized gas fills the CNG tank.

It is understood that the above-described system is applicable in any situation where high compression rates are desired. Though the system is described herein as utilizing a natural gas, it is further understood that the system may pressurize any gas or mixture of gases, including, for example, air, fuel gas, hydrogen, or the like.

1. A system for compressing gas, the system comprising:
a source of gas;
a gas output location;
first and second pressure vessels;
first and second gas input lines for directing gas from the source of gas respectively to the first and second pressure vessels;
first and second gas output lines for directing gas respectively from the first and second pressure vessels to the gas output location;
a hydraulic system for moving hydraulic fluid back and forth between the first and second pressure vessels to compress gas in the first and second pressure vessels in an alternating manner, wherein gas is pressurized in the first pressure vessel by directing a first charge of gas from the source of gas into the first pressure vessel through the first gas input line and moving hydraulic fluid from the second pressure vessel to the first pressure vessel to compress the first charge of gas within the first pressure vessel, and wherein gas is pressurized in the second pressure vessel by directing a second charge of gas from the source of gas into the second pressure vessel through the second gas input line and moving hydraulic fluid from the first pressure vessel to the second pressure vessel to compress the second charge of gas within the second pressure vessel; and
wherein the first and second pressure vessels each include a plurality of tubes for containing the gas as the gas is pressurized and for absorbing heat generated as the gas is compressed.

2. The system of claim 1, wherein the tubes are parallel to one another.

3. The system of claim 2, wherein the tubes are arranged in a single row.

4. The system of claim 2, wherein the tubes are arranged in an array including multiple parallel rows.

5. The system of claim 1, wherein the hydraulic fluid and the gas are directed inside the tubes and are not directed outside the tubes.

6. The system of claim 1, wherein the hydraulic fluid and the gas are directed both inside and outside the tubes.

7. The system of claim 1, wherein the tubes have opposite first and second ends respectively mounted to first and second headers, wherein the hydraulic system is fluidly connected to the first headers and the gas input and output lines are fluidly connected to the second headers.

8. The system of claim 1, wherein the tubes have outer diameters less than 5 millimeters.

9. The system of claim 8, wherein the tubes have wall thicknesses in the range of 0.2 to 4 mm.

10. The system of claim 1, wherein the system is capable of outputting a maximum gas pressure less than or equal to 4500 psi.

11. The system of claim 1, wherein the system is capable of outputting a maximum gas pressure less than or equal to 4000 psi.

12. The system of claim 1, wherein the first and second pressure vessels each have a volume less than 10 liters.

13. The system of claim 1, wherein first and second output one-way flow valves are respectively provided along the first and second gas output lines for allowing gas to flow from the first and second pressure vessels to the gas output location, and wherein first and second input one-way flow valves are respectively provided along the first and second gas flow lines for allowing gas to flow from the source of gas to the first and second pressure vessels.

14. The system of claim 1, wherein the hydraulic system includes a hydraulic flow line that fluidly connects the first and second pressure vessels together and a hydraulic pump for moving hydraulic fluid through the hydraulic flow line between the first and second pressure vessels.

15. The system of claim 14, further comprising a valve for controlling a direction of hydraulic fluid flow through the flow hydraulic flow line, wherein when the valve is in a first position the hydraulic fluid is pumped through the hydraulic flow line from the second pressure vessel into the first pressure vessel, and wherein when the valve is in a second position the hydraulic fluid is pumped through the hydraulic flow line from the first pressure vessel to the second pressure vessel.

16. The system of claim 14, wherein a heat exchanger is positioned along the hydraulic flow line for cooling the hydraulic fluid.

17. A method for compressing gas, the method comprising:
directing a charge of gas to a plurality of tubes in a first pressure vessel;
moving hydraulic fluid into the pressure vessel to compress the charge of gas; and
absorbing heat of compression with the plurality of tubes as the charge of gas is compressed.

18. (canceled)

19. (canceled)

20. (canceled)

21. The method of claim 17, wherein the vessel is a compressed gas tank positioned within a vehicle.

22. The method of claim 17, wherein the plurality of tubes is arranged in an array.

23. (canceled)

24. (canceled)

25. A pressure vessel in a compression system, the pressure vessel comprising:
a plurality of tubes arranged in an array, the plurality of tubes each configured to assist in a compression process by receiving a first charge of gas and a volume of hydraulic fluid, wherein the volume of hydraulic fluid compresses the first charge of gas thereby resulting in an output of heat, and wherein the plurality of tubes absorbs an amount of the output of heat to control a temperature increase of the gas during compression.
